(19) United States
(12) Patent Application Publication
(10) Pub. No.: US 2015/0335007 A1
(43) Pub. Date: Nov. 26, 2015

(54) Bird Deterrent with Built-In Adhesive

(71) Applicant: Bird-B-Gone, Inc., Mission Viejo, CA (US)

(72) Inventor: Bruce Donoho, Mission Viejo, CA (US)

(21) Appl. No.: 14/718,509

(22) Filed: May 21, 2015

Related U.S. Application Data
(60) Provisional application No. 62/001,216, filed on May 21, 2014.

(51) Int. Cl. A01M 29/26; E04B 1/72; A01M 29/32; A01M 29/24

(52) U.S. Cl. CPC A01M 29/26; A01M 29/24; E04B 1/72; A01M 29/32

(57) ABSTRACT

Ready to install animal deterrent devices are provided. Contemplated devices include an elongated base coupled to conductors and/or spikes and an adhesive such that no separate adhesive or fastener is required for installation. The adhesive can cover the entire bottom surface of the deterrent device or a part of it. Suitable adhesives can include one-, two- or multipart adhesives. Suitable adhesives can also cure in the presence of moisture, light, or heat. The deterrent device can further include a strip of material to cover the adhesive until deterrent device is installed.

This application claims the benefit of priority of U.S. Provisional Application No. 62/001,216, filed on May 21, 2014. This and all other extrinsic materials discussed herein are incorporated by reference in their entirety.

### FIELD OF THE INVENTION

The field of the invention is animal and pest deterrents, including bird deterrents.

### BACKGROUND

The following description includes information that may be useful in understanding the present invention. It is not an admission that any of the information provided herein is prior art or relevant to the presently claimed invention, or that any publication specifically or implicitly referenced is prior art.

Numerous devices for deterring animals or pests are known in the art, many of which use spikes or electric current as a deterrent. For example, some known devices using electrical current are described in U.S. Pat. No. 4,015,176, EPO Patent No. 1314355, U.S. Pat. No. 5,031,353, U.S. Pat. No. 6,006,698, U.S. Patent Publication No. 2005/0132635, U.S. Pat. No. 6,283,064, and U.S. Pat. No. 6,928,768. Exemplary devices using spikes are described in U.S. Pat. Nos. 8,443,543, 8,479,457, and 8,689,498.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Unfortunately, known deterrent devices require that the user either (1) install the deterrent devices using nails or screws, which can be incompatible for use on ledges made of metal, concrete, or glass, or (2) carry a separate glue or adhesive for installing the deterrent devices, which can be burdensome.

U.S. Pat. No. 7,249,436 attempts to overcome the problems discussed above and discloses a tape for deterring birds and animals. The tape comprises a base material with adhesive layers on the top and bottom surfaces. The top surface is covered with a film, and conducting strips are adhered to the film. The bottom surface is covered with a liner material. Upon removal of the liner material, the tape is applied to prepared surfaces.

Unfortunately, this method suffers from several disadvantages. As examples, the top adhesive and film layers are generally wasted, and water may pool at the edges of the tape structure.

Thus, there is still a need for improved deterrent devices that are ready to install.

### SUMMARY OF THE INVENTION

The inventive subject matter provides apparatus, systems and methods for deterrent devices having a built-in adhesive.

Exemplary deterrent devices include an elongated base having a bottom surface and a top surface. Conductors, spikes, or a combination of conductors and spikes can be coupled to the top surface, and an adhesive is applied to the bottom surface. The adhesive can cover all or part of the bottom surface and can comprise a set of non-contiguous adhesive segments disposed along a length of the bottom surface. Each segment of the set of adhesive segments can be configured in a variety of patterns, for example stripes that are parallel or perpendicular to a side of the base.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The deterrent device can also include a strip of material that covers the adhesive until the user is ready to install the deterrent device. Alternatively, the adhesive can be non-adherent until exposed to at least one agent. Exemplary agents include: water, UV light, and heat.

The base of the deterrent device can further comprise a trough formed on the bottom surface of the base, and the adhesive can be deposited within the trough. Adhesive foams and calking are suitable for deposition within such troughs. To protect adhesives from drying or moisture, the adhesives can be covered with blister seals.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A is a schematic of one embodiment of an electrified bird deterrent device.

FIG. 1B is a cross-section view of the bird deterrent device of FIG. 1A.

FIG. 1C is a bottom view of the bird deterrent device of FIG. 1A.

FIG. 2 is a bottom view of another embodiment of an electrified bird deterrent device without troughs.

FIG. 3 is a bottom view of another embodiment of an electrified bird deterrent device with a predisposed compound.

FIG. 4. is a schematic of a bird and/or pest deterrent system that has spikes.

FIG. 5 is a bottom view of another embodiment of an electrified bird deterrent device with two strips of material and a cavity.

FIG. 6. is a schematic of a bird and/or pest deterrent system that has spikes and adhesive segments.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Exemplary deterrent devices include a base, conductors and/or spikes, an adhesive for installing the deterrent device, and an optional strip of material to protect the adhesive until the user is prepared to install the deterrent device.

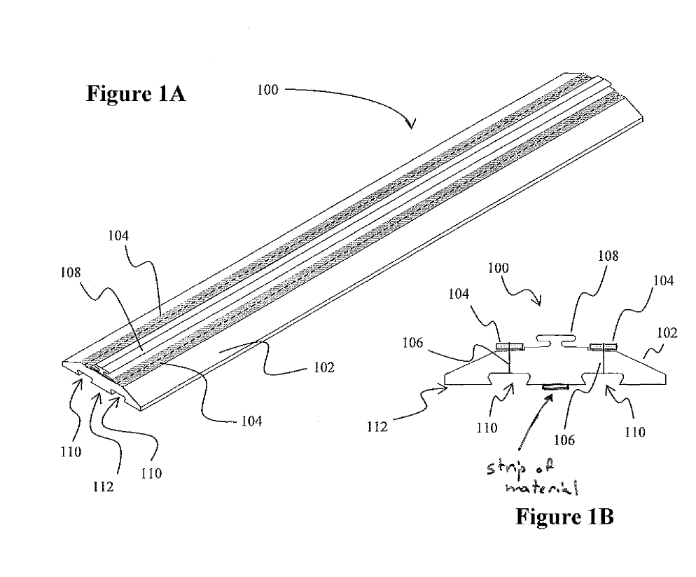

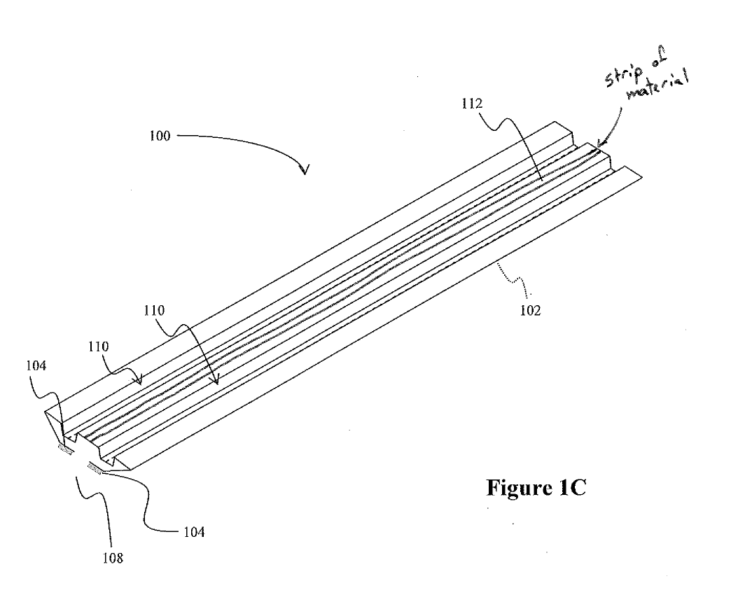

FIGS. 1A-1C illustrate an exemplary bird deterrent device of the inventive subject matter having a built-in adhesive. Deterrent device 100 is an electrical deterrent device having an elongated base 102. Base 102 preferably comprises one or more materials that are non-conductive and provide sufficient flexibility such that the base 102 can conform to uneven surfaces, for example, a rubber or plastic compound. However, it should be appreciated that any commercially suitable material(s) could be used.

Typically, base 102 has a flexible strip, track, or otherwise elongated configuration. Base 102 is relatively flat (e.g., having a width and length that is larger than the height) such that the device 100 can be bent, or even provided in a rolled-up configuration. The dimensions of the base can vary depending on, for example, the size of bird or other animal to be deterred. Typically, the base 102 will be configured such that device 100 has a height to width ratio between 1:10 and 1:2, more typically between 1:5 and 1:2, and more typically between 1:4 and 1:3. For example, suitable bases may have a width between 1 cm and 10 cm, more typically between 2 cm and 7 cm, and most typically between 3 cm and 5 cm. The length of such devices is generally determined by the desired overall length of the device or device segment and may therefore vary between several cm and several meters and even longer. The height of contemplated devices will generally be between 1 mm and 3 cm, and more typically between 3 mm and 1 cm.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Base 102 has at least one and preferably two electrical conductors 104 that extend longitudinally along a length of the base 102. Although it is preferred that the conductors 104 extend along the entire length of the base 102, it is contemplated that the conductors could extend along only a set portion of the base 102. Where the base 102 has two conductors, the conductors 104 are typically spaced apart at a distance that allows formation of an electric circuit when a foot of a bird (e.g., an adult pigeon, an adult seagull) rests on the device 100. Therefore, and depending on the particular bird, suitable distances between first and second conductors can be between 5.0 mm and 2.0 cm, and more typically between 0.7 and 1.5 cm.

The conductors 104 are knitted, although braided and other types of conductors are contemplated. It is especially preferred that the conductors 104 comprise at least one conducting strand knitted with at least itself, or with additional conducting strands, to form an elongated conducting band. The conducting band can be knitted as a flat sheet, a tube, or even multiple tubes nested within each other. It is also contemplated that the conducting band can include a non-braided or non-warp and weft mesh, woven strand. A detailed discussion of various types of knitted conductors can be found in U.S. Pat. Nos. 8,196,340 and 8,424,238, both of which are incorporated by reference.

Preferred conductors are manufactured from robust conducting metals capable of withstanding outdoor extremes. Example suitable conducting metals include stainless steel (e.g., 316L), or other conducting materials that are resistant to corrosion and are suitable for outdoor use. One acceptable conducting material includes Monel®, which has improved electrical conductivity over many stainless steels. A currently preferred conductor for use in an outdoor deterrent device includes corrosion resistant copper, ETP 0.005 inch diameter, tin-plated knitted wire mesh stocking (e.g., tube).

The conductors 104 are sewn to the base 102 using a fabric or plastic (e.g., nylon) thread 106, but could alternatively be coupled to the base 102 using any commercially suitable fastener(s) including, for example, glue and other adhesives, plastic or metal staples, friction fit, thermal coupling, and any combination(s) thereof. Where sewn to base 102, it is preferred that the conductors 104 are sewn such that the thread extends from the conductor to a trough or portion of the base that doesn't contact a mounting surface. For example, the thread could extend into a trough or indentation on a bottom surface of the base, or to an internal cavity of the base. Conductors 104 may be coupled to the base 102 on a horizontal or angled surface of base 102.

Base 102 includes a raised portion 108 that separates the conductors 104 and functions as an arc suppressor. In some contemplated embodiments where such raised portion is included, the raised portion 108 can have an umbrelloid shape. A more detailed discussion of possible arc suppressors can be found in U.S. Pat. Nos. 7,802,396 and 7,937,885, both of which are incorporated by reference.

Where desired, at least part of the base 102 and/or at least part of the raised portion 108 can be angled, and the angle could be selected such that when the device 100 is installed on horizontal surface water runs off the angled part.

It is contemplated that the base 102 could optionally include troughs 110 on its bottom surface, which are essentially channels, notches, or grooves that result in a discontinuous bottom surface of the base 102. It is especially preferred that the troughs 110 are disposed beneath the conductors 104. Where the conductors 104 are sewn to the base 102, it is contemplated that the conductors 104 can be sewn such that the thread or other fastener extends from the conductor 104 to the trough 110, resulting in a seam along the conductor 104 and trough 110, as shown in FIGS. 1A-1B.

To assist in allowing the base to be adhered to a surface, it is contemplated that a bottom surface of the base 102, or a portion thereof, could have a built-in or predisposed adhesive. For example, in some contemplated embodiments, an adhesive could be applied to the bottom surface during manufacture of the base 102, and a strip of wax paper or other material can be used to cover the adhesive until installation of the base 102. During installation, the strip could then be removed, exposing the adhesive and allowing the base 102 to be adhered to a mounting surface.

It is desirable to install deterrent devices on a variety of structures made of diverse materials. For example, deterrent tracks are often installed on the ledges of buildings, on free-standing birdfeeders, under awnings, and on billboards, among others. These structures can be made of wood, metal, glass, plastics, ceramics, paints and other materials. Therefore, suitable adhesives bond the deterrent device to these materials. The bond between the base 102 and the material may be temporary or permanent. For temporary installations, preferable mechanisms for removing the deterrent device will not significantly damage the underlying material. For long-term installations, the bond between the base 102 and materials should resist degradation in extreme weather and remain stable within a wide range of temperatures and humidity levels.

The inventors contemplate that suitable adhesives can include natural or synthetic compositions. Natural adhesives include starch- and protein-based glues. Contemplated embodiments employ glues made of dextrins, casein, animal hides, gelatin, and albumin, for example. Starch- and protein-based adhesives are generally water-based. In cases where it is desirable to temporarily install the deterrent devices, such glues can be conveniently washed away with water. Natural resins can also serve as suitable adhesives.

Suitable synthetic adhesives include elastomers, thermoplastics, emulsions, and themosets. In some aspects of the inventive subject matter, elastomers comprise polyisoprenes, polybutadienes, polyisobutylene, polyurethanes, and silicone rubbers. Other embodiments employ polymer-based adhesives, such as cyanoacrylates, urethanes, acrylics, and epoxies. Cyanoacrylates adhere strongly to most materials but may damage plastics, such as polycarbonate. Acrylic adhesives bond well with plastics and are preferred for adhering the base of the deterrent device to plastic mounting surfaces. Urethane adhesives are selected where the adhesive must retain flexibility. Epoxies can be used to adhere the base 102 to a variety of substrates, namely, plastics, rubbers, wood, and metals. Advantageously, synthetic adhesives feature good weather resistance. Durable synthetic adhesives are suitable for long-term installations.

In further contemplated embodiments, the adhesive may comprise a high surface area material (e.g., polydimethylsiloxanes). High surface area materials mimic the ability of gecko feet to cling to surfaces through van der Waals forces.

Drying polymers, e.g., polyvinyl acrylate, rubber cements, glues may also be employed. In contemplated embodiments, premature drying can be prevented by sealing the glue on the bottom of the base with a blister seal. It should be appreciated that the adhesives can be formulated as liquid, paste, gel, caulk, putty, foam, semi-solids, solids, powders, or tapes depending on the desired mounting surface and application method. The adhesives can be applied to the base by a variety of means including, dipping, rolling, brushing, stamping, or printing. Alternatively, the adhesive can be applied in the form of a double-sided tape or foam adhesive. The adhesive may cover the entire bottom surface or only a portion of it. In exemplary embodiments of the inventive subject matter, 5%, 10%, 25%, 50%, or 75% of the bottom surface of the base can be coated with adhesive. In yet further embodiments, the adhesive can be embedded in the base material.

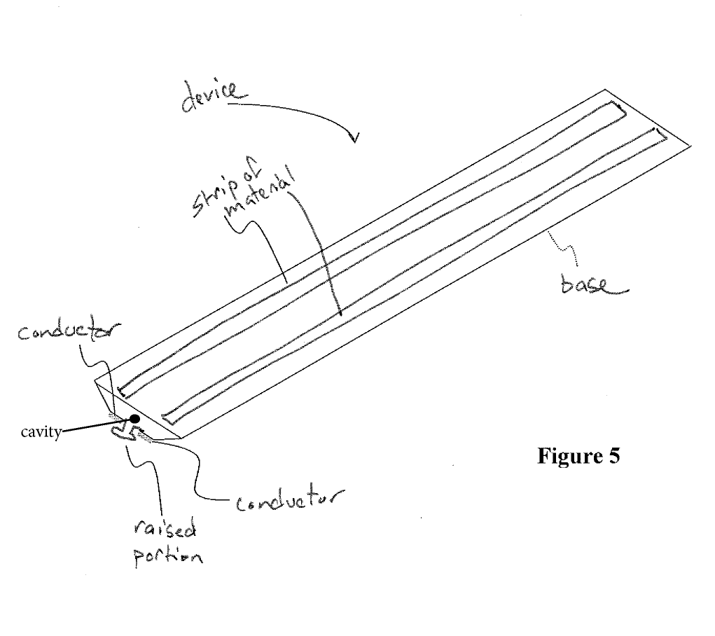

As illustrated in FIG. 1C, the adhesive can be positioned down the central, longitudinal axis of the bottom of base 102. The glue can also be deposited in two or more longitudinal stripes (adhesive segments) as depicted in FIG. 5. The longitudinal stripes of adhesive may be positioned on the bottom of base 102 on either side of troughs 110. As depicted in these figures, the stripe(s) of adhesive are substantially parallel with an edge of the deterrent device. As used herein substantially parallel can mean parallel or within 20 degrees of parallel, more commonly within 10 degrees of parallel. In further contemplated embodiments, the adhesive may be positioned in stripes substantially perpendicular to an edge of the base. As used herein the term substantially perpendicular shall mean within 20 degrees of perpendicular, more commonly within 10 degrees of perpendicular to an edge of the bird deterrent. Other embodiments are contemplated in which stripes of adhesive are applied at other angles with respect to the edge of the base. In yet further contemplated embodiments, the segments of adhesive can be dots of adhesive applied to the bottom surface of base 102. In addition to dots, the adhesive segments can be applied in other patterns such as a checkerboard or zigzag patterns. The adhesive segments may be contiguous or non-contiguous.

In yet further contemplated embodiments, the adhesive may be used to fill troughs 110. This configuration is advantageous where it is desirable to keep moisture from wicking up the threads used to sew conductors 104 to base 102. In yet further contemplated embodiments, the adhesive is an adhesive foam or calk, which fills the troughs. Foam can also be predisposed on the bottom of base 102, wherein the base lacks troughs. The foam adhesive will spread upon pressing the base against the mounting surface, spreading the adhesive and increasing the area of the adhesive between the deterrent device and the mounting surface.

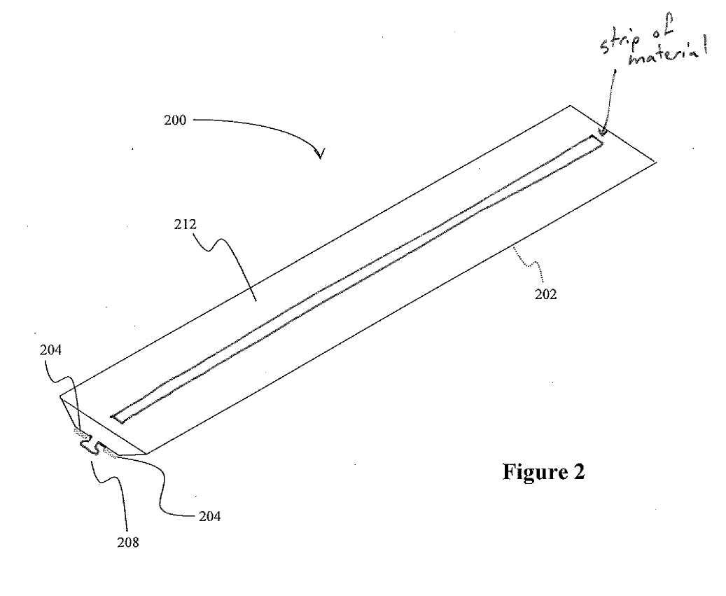

FIG. 2 illustrates another embodiment of an electrical deterrent device 200 having a flat bottom 212 and an adhesive strip optionally covered with a strip of material. With respect to the remaining numerals in FIG. 2, the same considerations for like components with like numerals of FIG. 1 apply. Conductors 204 are shown on either side of a T-shaped raised portion 208. The conductors can be thermally coupled to the base 202 or via a friction-fit.

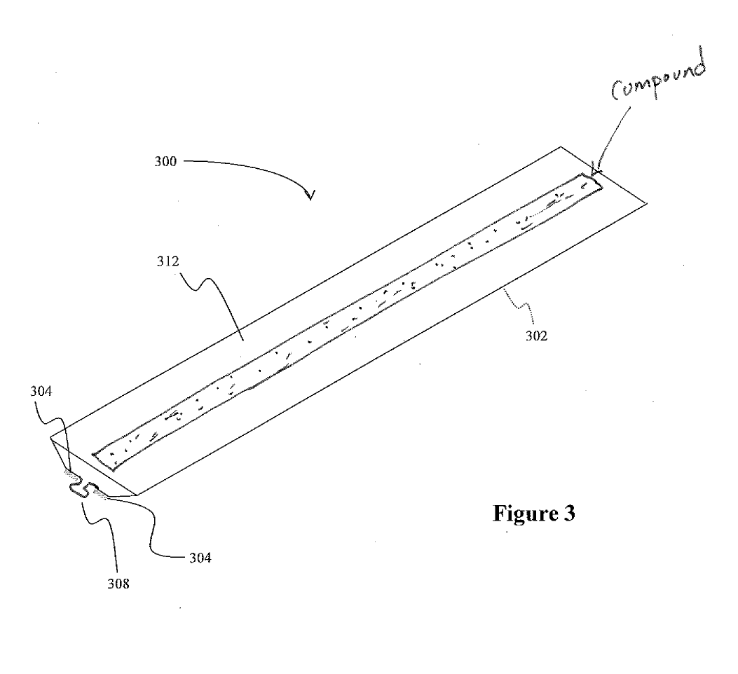

Rather than utilize a predisposed adhesive having a strip of material covering the adhesive, the base could include a chemical composition that activates at the presence of an agent as shown in FIG. 3. This advantageously eliminates the possibility that the strip covering the adhesive could be unintentionally removed while still simplifying the installation process of the deterrent device. Thus, in such embodiments, the compound could be disposed on the bottom surface of the base in a non-adherent first state, and can transition to an adherent, second state when contacted with an agent, such as water or an energy source.

Contemplated compounds comprise one-, two- or multi-part adhesives. Some contemplated adhesives can cure by reaction upon exposure to radiation, heat, moisture, or light. UV-curing adhesives such as acrylate-based polymers are suitable for applying the deterrent to glass surfaces and where the transparency of the adhesive is desirable. In further aspects of the inventive subject matter, methyl methacrylate or acrylated urethane adhesives may be deposited onto the bottom surface of the deterrent device. After placing the deterrent device over a glass substrate, UV light can be transmitted through the glass substrate to cure the deposited acrylic adhesive.

In further contemplated embodiments, epoxies, urethanes, polyimides may be deposited on the bottom surface of the deterrent device. After the device is placed on the desired substrate, the application of heat cross-links the adhesive components, forming a strong bond between the deterrent device and the substrate.

In yet further contemplated embodiment, cyanoacrylate and/or urethane adhesives can be deposited on the bottom surface of the base. Cyanoacrylate and urethane adhesives cure in the presence of moisture. Most commonly, cyanoacrylate adhesives comprise one or more of methyl 2-cyanoacrylate, ethyl 2-cyanoacrylate, n-butyl cyanoacrylate, and 2-octyl cyanoacrylate. Moisture cure polyurethanes include hyperbranched polyurethane-urea polymers and isocyanate terminated polyurethanes. While ambient moisture is typically sufficient to cure such adhesives, the inventors contemplate moistening the substrate by wiping, spraying, dipping, painting, or otherwise applying water to the surface where the deterrent device will be mounted. To prevent the adhesive from curing while on the shelf, the adhesives can be sealed onto the base of the deterrent device using blister seal packaging.

Pressure-sensitive adhesives bind to an adherend (i.e., mounting surface) upon application of pressure, sometimes with the addition of heat. Typical pressure sensitive-adhesives include acylate-based polymers. Pressure-sensitive adhesives may be used in temporary and permanent applications. In temporary applications, pressure-sensitive adhesives advantageously leave no residue on the adherend.

Contact adhesives such as natural rubber and polychloroprene (neoprene) can also be predisposed on the bottom surface of the base of the deterrent device. In contemplated embodiments, the contact adhesive is applied to the substrate where the deterrent device will be mounted. Upon optional curing/drying the adhesive on the deterrent device is aligned with the adhesive on the substrate, and the adhesive surfaces are brought into contact, bonding the deterrent device to the substrate.

Two part adhesives can also be employed to adhere the deterrent device to the mounting surface. Polyester resins, cyanoacrylates, acrylics, urethanes, and epoxies can be formulated as two part adhesives. Two part adhesives often comprise a pre-polymer that is mixed with a catalyst that accelerates curing of the adhesive. In contemplated embodiments, one component can be applied to the base, and the other component can be applied to the substrate. When the two components are put in contact, curing is initiated, bonding the bird deterrent to the mounting surface.

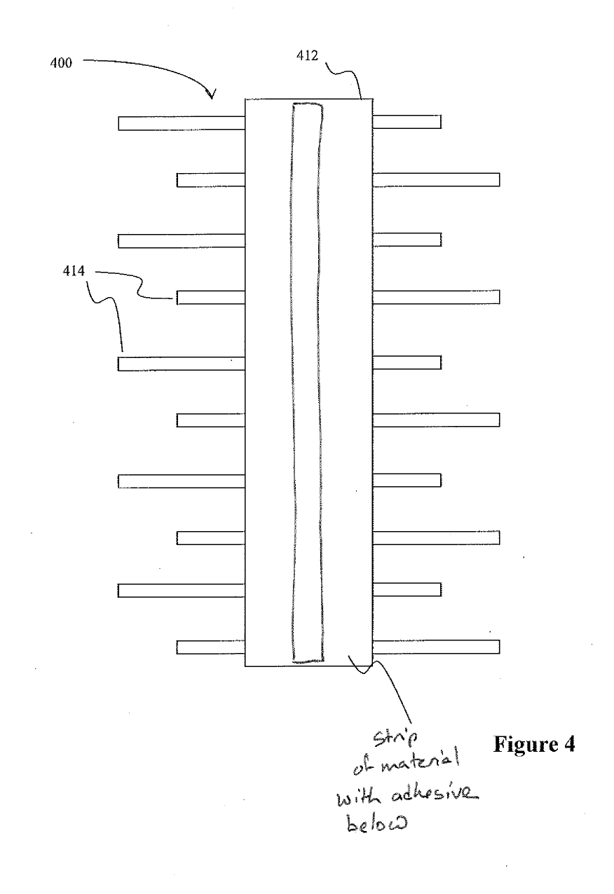

FIG. 4 illustrates one embodiment of a deterrent device having a base 412, a plurality of prongs or spikes 414 extending from the base 412, and an adhesive covered by a strip of material disposed on the bottom surface of base 412. It should be appreciated that any of the adhesives disclosed herein can be disposed on the bottom surface of base 412. It should be further appreciated that the adhesive may be disposed in any of the configurations disclosed, for example, stripes, dots, checker-board patterns, etc.

The prongs 414 are provided at various angles relative to the underlying surface. In some contemplated embodiments, the prongs 414 can be oriented at various angles, such as 90 degrees relative to the underlying surface, 30 degrees above the underlying surface, and about 70 degrees above the underlying surface. Moreover, some of the prongs 414 an be disposed on opposed sides of the base 412. Such orientation of the prongs 414 forms a repetitive pattern along the length of the base 412. The base 412 can optionally include a trough. The base 412 and prongs 414 preferably form a unitary structure, such as via injection molding, although it is alternatively contemplated that the base and prongs can be coupled to one another and/or be formed of different materials. A unitary structure permits the device to be fabricated as a single injection-molded plastic member obviating any further assembly before installation on an underlying surface, which reduces fabrication costs and simplifies installation.

FIG. 5 illustrates another embodiment of a deterrent device having multiple adhesive areas with two strips of material covering the adhesive areas. It is contemplated that a single strip of material could be used to cover the multiple adhesive areas. Additionally, the adhesive may be disposed in troughs covered by one or more strips of material. The deterrent device also features a raised portion, conductors, and a cavity. It should be appreciated that any of the embodiments disclosed can feature a cavity. It should further be appreciated that the cavity can take a variety of suitable shapes, and a single base may include multiple cavities. Such cavities advantageously save on material used to make the base and increase the flexibility of the deterrent device.

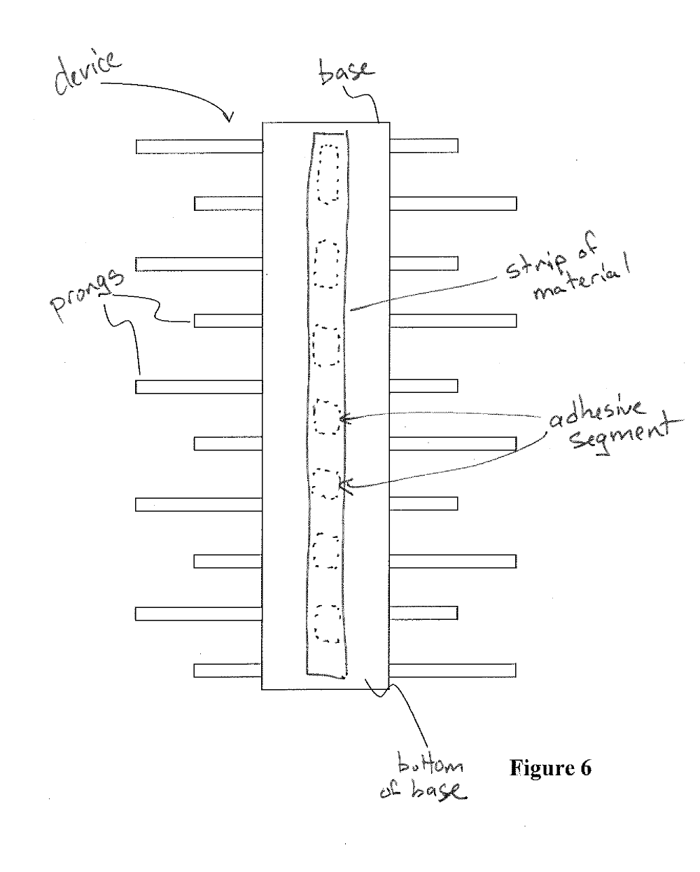

FIG. 6 illustrates another embodiment of a deterrent device having a plurality of adhesive segments covered by a removable strip of material. The adhesive can be applied in a dot pattern or as a pattern of diamonds, squares, stripes, grid etc. Each segment can intersect or be non-contiguous.

It is contemplated that the strip could comprise a single strip that runs along all or substantially all of a length of the base. However, in alternative embodiments, the base could include a set of non-contiguous strips along its bottom surface, which could run parallel, perpendicular, or on diagonal angles to a side of the base. In still other contemplated embodiments, the adhesive could be disposed on the bottom surface in segments that are non-contiguous, but a single strip of material could be used to cover all of the segments of adhesive. As previously described, the strip of material can be a piece of waxed paper. For example, the waxed paper may be used to cover the mounting side of a double sided tape. The strip of material may comprise a blister pack, sealed at the periphery of the adhesive or base. The strip material may also be the deterrent itself, as when the deterrent is rolled up on itself. Where it is necessary to protect the adhesive, the roll can be sealed in a blister pack or other sealed packaging. Depending on the adhesive, the strip of material can also be cloth, plastic, or Teflon.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A deterrent device, comprising:
an elongated base having a bottom surface and a top surface;
at least one of a conductor and a spike coupled to the top surface; and
wherein the bottom surface comprises a set of non-contiguous adhesive segments disposed along a length of the bottom surface.

2. The deterrent device of claim 1, wherein each segment of the set of adhesive segments are substantially parallel or substantially perpendicular to a side of the base.

3. The deterrent device of claim 1, wherein the adhesive segments of the set of adhesive segments are disposed along at least 75% of a length of the bottom surface.

4. The deterrent device of claim 3, wherein at least some of the adhesive segments of the set of adhesive segments are contiguous.

5. The deterrent device of claim 1, further comprising a strip of material sized and dimensioned to cover the set of adhesive segments.

6. The deterrent device of claim 6, wherein the strip of material is removably coupled to the adhesive.

7. A deterrent device, comprising:
an elongated base having a bottom surface and a top surface;
at least one of a conductor and a spike coupled to the top surface; and
wherein the bottom surface comprises an adhesive, wherein the adhesive is non-adherent until exposed to at least one agent.

8. The deterrent device of claim 7, wherein the at least one agent comprises water.

9. The deterrent device of claim 7, wherein the at least one agent comprises UV light.

10. The deterrent device of claim 7, wherein the at least one agent comprises heat.

11. The deterrent device of claim 1, wherein the at least one of the conductor and the spike comprises the conductor.

12. The deterrent device of claim 11, wherein the conductor comprises a braided wire.

13. The deterrent device of claim 11, wherein the conductor comprises a knitted wire.

14. The deterrent device of claim 11, wherein the conductor is coupled to the base via sewing.

15. The deterrent device of claim 11, wherein the conductor is attached to the base via a friction-fit.

16. The deterrent device of claim 11, wherein the conductor is thermally coupled to the base.

17. The deterrent device of claim 1, wherein the base further comprises a trough formed on the bottom surface of the base.

18. The deterrent device of claim 17, wherein the adhesive segments of the set of adhesive segments are at least partially disposed within the trough.

19. The deterrent device of claim 18, wherein the adhesive segments of the set of adhesive segments comprise an adhesive foam.

20. The deterrent device of claim 19, wherein the adhesive foam is covered with a blister seal.

21. The deterrent device of claim 1, wherein the base further comprises an internal cavity.
